(19) United States
(12) Patent Application Publication
(10) Pub. No.: US 2008/0079925 A1
(43) Pub. Date: Apr. 3, 2008

(54) PROCESSING APPARATUS

(75) Inventor: Shinichi HIRANO, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 11/860,844

(22) Filed: Sep. 25, 2007

(30) Foreign Application Priority Data
Sep. 29, 2006 (JP) 2006-269021

(51) Int. Cl. G03B 27/58

(52) U.S. Cl. 355/72

(57) ABSTRACT

A processing apparatus comprises a processing unit configured to process an object, and a controller configured to send a signal for requesting an external apparatus to perform conveyance of the object into or out of the processing apparatus before the processing apparatus enters a state in which the external apparatus can perform the conveyance.

### BACKGROUND OF THE INVENTION

1. Field of the Invention

The present invention relates to a processing apparatus and, more particularly, to a processing apparatus that processes an object.

2. Description of the Related Art

Normally, an exposure apparatus for manufacturing a device such as a semiconductor device is used when connecting to a coater/developer. The exposure apparatus and coater/developer exchange a wafer coated with a photosensitive agent. A wafer inlet/outlet station is interposed between the exposure apparatus and the coater/developer. The exposure apparatus requires that after removing the wafer set on the wafer inlet/outlet station, the coater/developer to supply the next wafer at the time the apparatus becomes ready to receive it.

In transferring an exposed wafer to the coater/developer, the exposure apparatus requests the coater/developer to remove it from the wafer inlet/outlet station at the timing when the apparatus sets it on the wafer inlet/outlet station and the coater/developer becomes ready to receive it.

In the above-described scheme of requesting the coater/developer to supply the next wafer at the timing when the exposure apparatus becomes ready to receive it, the coater/developer activates a wafer conveyance unit in response to the request. Let T be the time required to actually set a wafer on the inlet/outlet station after the coater/developer receives a wafer supplying request. Then, the exposure apparatus cannot receive the next wafer until the time T elapses after the timing when the apparatus becomes ready to receive the wafer.

Also in the above-described scheme of requesting the coater/developer to remove a wafer from the inlet/outlet station at the timing when the coater/developer becomes ready to receive it, the coater/developer activates the wafer conveyance unit in response to the request. Let T be the time required to remove a wafer from the inlet/outlet station after the coater/developer receives a wafer remove request. Then, the exposure apparatus cannot set the next wafer on the inlet/outlet station until the time T elapses after the timing when the coater/developer becomes ready to receive it.

### SUMMARY OF THE INVENTION

The present invention has been made in consideration of the above backgrounds, and has as its exemplary object to improve throughput of a process performed by a processing apparatus.

According to the present invention, there is provided a processing apparatus comprising a processing unit configured to process an object, and a controller configured to send a signal for requesting an external apparatus to perform conveyance of the object into or out of the processing apparatus before the processing apparatus enters a state in which the external apparatus can perform the conveyance.

Further features of the present invention will become apparent from the following description of exemplary embodiments with reference to the attached drawings.

### BRIEF DESCRIPTION OF THE DRAWINGS

FIG. 1 is a view showing the schematic arrangement of the main part of an exposure apparatus according to a preferred embodiment of the present invention;

FIG. 2 is a view showing the schematic arrangement of a lithography system according to the preferred embodiment of the present invention;

FIG. 3 is a view showing an example of window display of an input/output unit serving as a user interface;

FIGS. 4A and 4B are timing charts showing operation examples for loading a wafer from a coater/developer to the exposure apparatus;

FIGS. 5A and 5B are timing charts showing operation examples for unloading a wafer from the exposure apparatus to the coater/developer;

FIG. 6A is a flowchart illustrating an operation example for loading a wafer from the coater/developer to the exposure apparatus in a normal mode;

FIG. 6B is a flowchart illustrating an operation example for loading a wafer from the coater/developer to the exposure apparatus in an output-advancing mode;

FIG. 7A is a flowchart illustrating an operation example for unloading a wafer from the exposure apparatus to the coater/developer in the normal mode;

FIG. 7B is a flowchart illustrating an operation example for unloading a wafer from the exposure apparatus to the coater/developer in the output-advancing mode;

FIG. 8 is a flowchart illustrating the operation of an exposure apparatus controller in a learning mode (wafer supplying request);

FIG. 9 is a flowchart illustrating the operation of the exposure apparatus controller in a learning mode (wafer removing request);

FIG. 10 is a flowchart illustrating the sequence of the overall semiconductor device manufacturing process; and

FIG. 11 is a flowchart illustrating the detailed sequence of the wafer process.

### DESCRIPTION OF THE EMBODIMENT

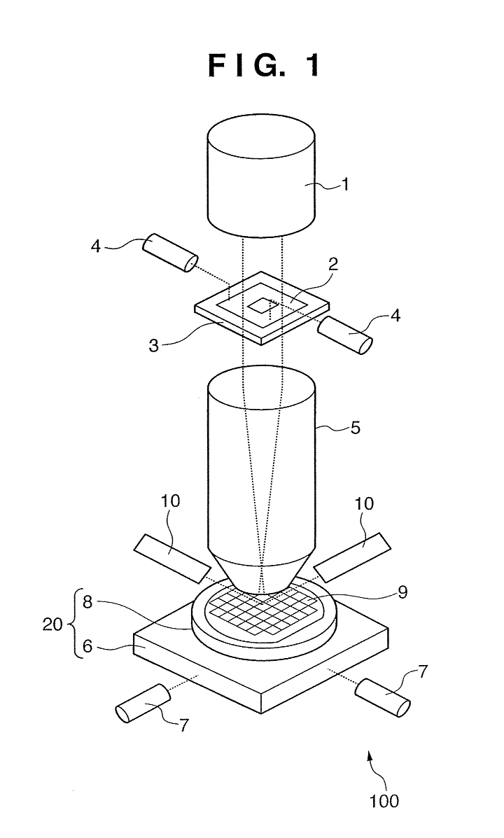

A preferred embodiment of the present invention will be described below with reference to the accompanying drawings. FIG. 1 is a view showing the schematic arrangement of the main part of an exposure apparatus according to the preferred embodiment of the present invention. An exposure apparatus 100 according to the preferred embodiment of the present invention comprises an illumination unit 1 which includes a light source, a reticle stage 3 for holding a reticle (original) 2 on which a pattern is formed, and a reticle position measurement unit 4 for measuring the position of the reticle 2 held by the reticle stage 3. The exposure apparatus 100 also comprises a projection optical system 5 and a stage unit 20 for aligning a wafer (substrate) 9 coated with a photosensitive agent. The stage unit 20 includes an X-Y stage 6 for aligning the wafer 9 in the X and Y directions, and a Z stage 8 for aligning the wafer 9 in the Z direction. The exposure apparatus 100 also comprises a laser interferometer 7 for measuring the position of the X-Y stage 6 in the X and Y directions, and a focus unit 10 for measuring the position of the wafer 9 in the Z direction. The pattern formed on the reticle 2 is projected onto the wafer 9 on the Z stage 8 via the projection optical system 5 to form a latent image pattern on the photosensitive agent applied to the wafer 9. A developer develops this latent image pattern into a physical pattern.

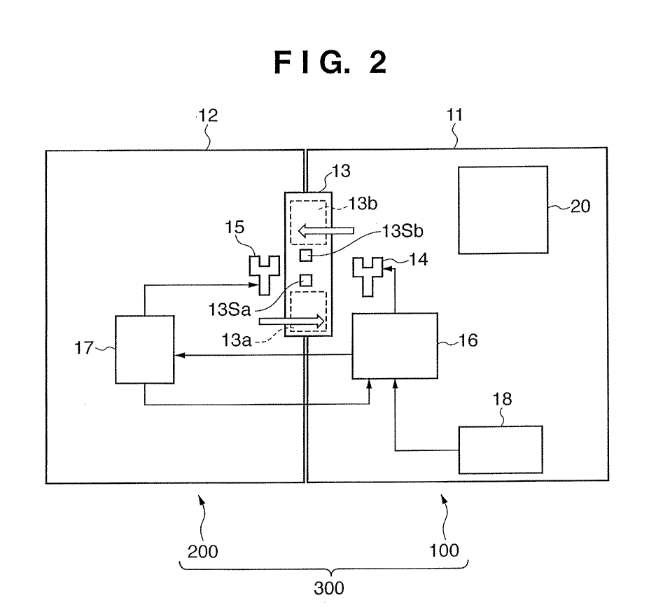

FIG. 2 is a view showing the schematic arrangement of a lithography system according to the preferred embodiment of the present invention. A lithography system 300 shown in FIG. 2 includes a coater/developer 200 and the exposure apparatus (processing apparatus) 100 having the main part shown in FIG. 1. The exposure apparatus 100 comprises an exposure chamber 11. The main part of the exposure apparatus 100, that is, an exposure unit (processing unit) is built in the exposure chamber 11. For the sake of simplicity, FIG. 2 shows only the stage unit 20 as the main part of the exposure apparatus 100. The exposure chamber 11 incorporates an exposure apparatus wafer conveyance unit (to be referred to as an EXPO conveyance unit hereinafter) 14, an exposure apparatus controller 16, and an input/output unit 18 serving as a user interface.

The coater/developer 200 comprises a coater/developer chamber 12. The main part of the coater/developer 200 is built in the coater/developer chamber 12. The coater/developer chamber 12 incorporates a coater/developer wafer conveyance unit (to be referred to as a CD conveyance unit hereinafter) 15 and coater/developer controller 17.

The EXPO conveyance unit 14 receives a wafer conveyed to a first position (loading station) 13a on an inlet/outlet station 13 by the CD conveyance unit 15, and conveys it onto the stage unit 20 in the exposure unit. The EXPO conveyance unit 14 conveys the exposed wafer to a second position (unloading station) 13b on the inlet/outlet station 13. The EXPO conveyance unit 14 sometimes conveys the wafer onto the stage unit 20 via a wafer alignment unit (not shown). The exposure chamber 11 sometimes incorporates a plurality of wafer conveyance units.

In the following description, “loading” means part or all of operations for conveying a wafer from the coater/developer 200 to the main part (stage unit 20) of the exposure apparatus 100 via the first position 13a on the inlet/outlet station 13. Also, “unloading” means part or all of operations for conveying a wafer from the exposure apparatus 100 to the main part of the coater/developer 200 via the second position 13b on the inlet/outlet station 13.

A “supplying request” or “conveying-in request” means a request issued from the exposure apparatus 100 to the coater/developer 200 so that the CD conveyance unit 15 supplies a wafer to the first position 13a on the inlet/outlet station 13. A “removing request” or “conveying-out request” means a request issued from the exposure apparatus 100 to the coater/developer 200 so that the CD conveyance unit 15 removes a wafer from the second position 13b on the inlet/outlet station 13. The exposure apparatus 100 issues the supplying request (conveying-in request) or removing request (conveying-out request) by generating (activating) a state signal representing that the apparatus 100 has entered a specific state. A supplying request (conveying-in request) signal is equivalent to a state signal representing that supply has been requested. A removing request (conveying-out request) signal is equivalent to a state signal representing that removal has been requested.

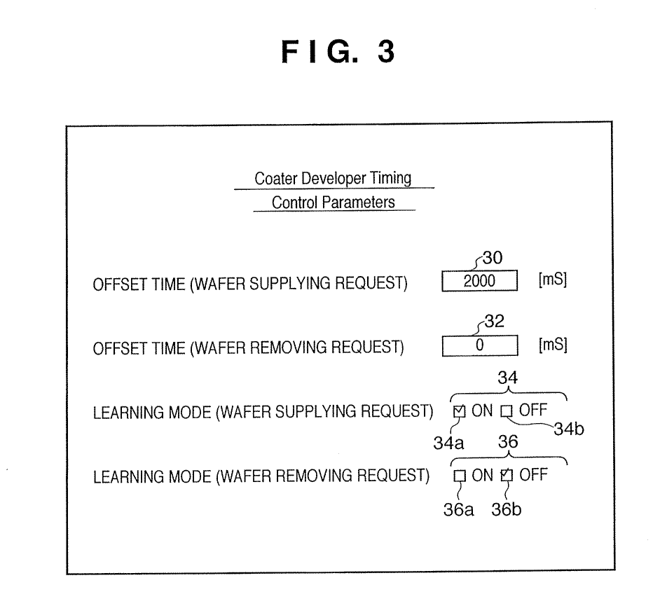

FIG. 3 is a view showing an example of window display of the input/output unit 18 serving as a user interface. Parameters displayed on the window of the input/output unit 18 will be explained here. An input field 30 is a field to input an “offset time (wafer supplying request)”. The “offset time (wafer supplying request)” means an offset time TP1 (to be described later) of a timing to generate a wafer supplying request (conveying-in request) signal to be sent from the exposure apparatus 100 to the coater/developer 200. The exposure apparatus 100 generates (activates) a wafer supplying request (conveying-in request) signal (Input-Request) at a timing earlier than a natural request timing by the offset time input to the input field 30. The natural request timing here means the timing when the exposure apparatus enters a state in which a request may be met at an offset-free request timing. For example, the timing when the exposure apparatus 100 enters a state in which a wafer may be supplied from the coater/developer 200 to the first position 13a on the inlet/outlet station 13 is the natural request timing of a supplying request (conveying-in request) signal. If the offset time input to the input field 30 is 0, the wafer supplying request (conveying-in request) signal (Input-Request) is generated at the natural request timing.

An input field 32 is a field to input an “offset time (wafer removing request)”. The “offset time (wafer removing request)” means an offset time TP2 (to be described later) of a timing to generate a wafer removing request (conveying-out request) signal to be sent from the exposure apparatus 100 to the coater/developer 200. The exposure apparatus 100 generates (activates) a wafer removing request (conveying-out request) signal (Wafer-Out) at a timing earlier than a natural request timing by the offset time input to the input field 32. As described above, the natural request timing here means the timing when the exposure apparatus enters a state in which a request may be met at an offset-free request timing. For example, the timing when the exposure apparatus 100 enters a state in which a wafer may be removed from the first position 13a on the inlet/outlet station 13 is the natural request timing of a removing request (conveying-out request) signal. If the offset time input to the input field 30 is 0, the wafer removing request (conveying-out request) signal (Wafer-Out) is generated at the natural request timing.

A check box 34 is used to switch on/off a “learning mode (wafer supplying request)” function. The “learning mode (wafer supplying request)” function is set ON upon inputting a check mark to an ON box 34a, while it is set OFF upon inputting a check mark to an OFF box 34b. In the learning mode (wafer supplying request), the time from when the exposure apparatus 100 outputs a wafer supplying request (conveying-in request) signal (Input-Request) to the coater/developer 200 until the coater/developer 200 supplies a wafer to the first position 13a on the inlet/outlet station 13 is measured. The offset time TP1 of a timing defined by the wafer supplying request (conveying-in request) signal is determined based on the measurement result. When the “learning mode (wafer supplying request)” function is set ON, the offset time input to the input field 30 is invalidated and the offset time determined based on the measurement result is used instead. When the “learning mode (wafer supplying request)” function is set OFF, the offset time input to the input field 30 is validated.

A check box 36 is used to switch on/off a “learning mode (wafer removing request)” function. The “learning mode (wafer removing request)” function is set ON upon inputting a check mark to an ON box 36a, while it is set OFF upon inputting a check mark to an OFF box 36b. In the learning mode (wafer removing request), the time from when the exposure apparatus 100 outputs a wafer removing request (conveying-out request) signal (Wafer-Out) to the coater/developer 200 until the coater/developer 200 removes a wafer from the second position 13b on the inlet/outlet station 13 is measured. The offset time of a timing defined by the wafer removing request (conveying-out request) signal is determined based on the measurement result. When the “learning mode (wafer removing request)” function is set ON, the offset time input to the input field 32 is invalidated and the offset time determined based on the measurement result is used instead. When the “learning mode (wafer removing request)” function is set OFF, the offset time input to the input field 32 is validated.

In the following description, a mode in which a wafer supplying request (conveying-in request) signal (Input-Request) or wafer removing request (conveying-out request) signal (Wafer-Out) is output at a timing earlier than the natural timing will be called an output-advancing mode, and a mode in which this signal is output at the natural timing will be called a normal mode.

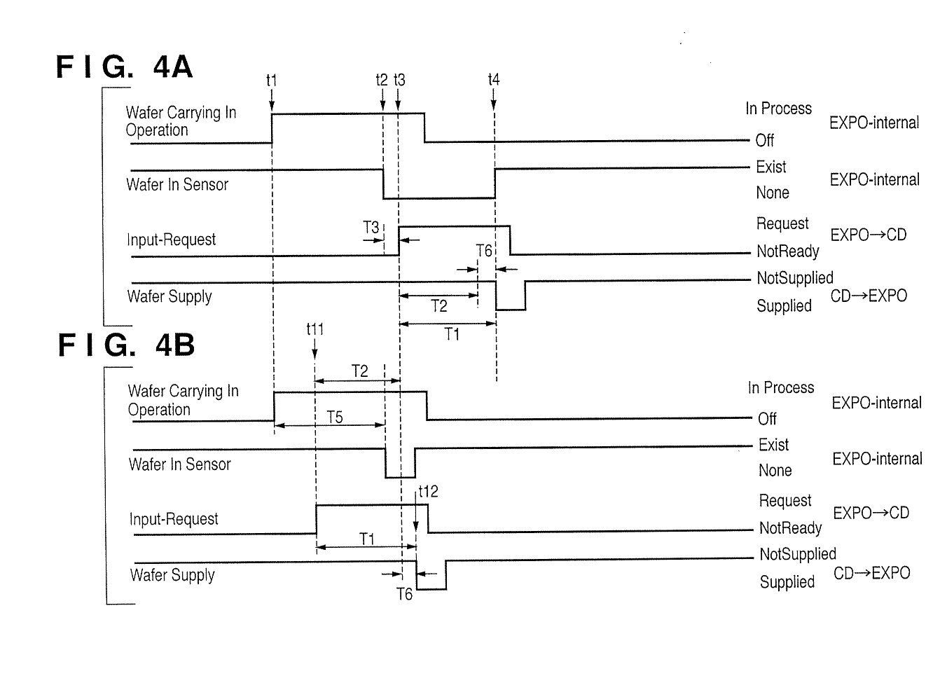

FIGS. 4A and 4B are timing charts showing operation examples for loading a wafer from the coater/developer 200 to the exposure apparatus 100.

FIG. 4A shows an operation example in the normal mode. FIG. 4B shows an operation example in the output-advancing mode. Signals shown in FIGS. 4A and 4B will be explained.

<Wafer Carrying In Operation Signal>

A Wafer Carrying In Operation signal is a state signal of the inside of the exposure apparatus 100 and indicates the operation state of the EXPO conveyance unit 14. This signal is in an In Process state or Off state while the EXPO conveyance unit 14 does or does not execute wafer conveyance.

<Wafer In Sensor Signal>

A Wafer In Sensor signal is a signal output from a wafer detection sensor 13Sa for detecting the existence and nonexistence of a wafer in the first position (loading station) 13a on the inlet/outlet station 13. This signal is in an Exist state or None state during the existence or nonexistence of a wafer.

<Input-Request Signal>

An Input-Request signal is a wafer supplying request (conveying-in request) signal (a state signal representing that wafer supply is requested) output from the exposure apparatus controller 16 to the coater/developer controller 17 of the coater/developer 200. The wafer supplying request (conveying-in request) signal is a signal with which the exposure apparatus 100 sends a request to the coater/developer 200 so that the CD conveyance unit 15 supplies a wafer to the first position 13a on the inlet/outlet station 13. This signal is in a Request state or NotReady state while wafer supply is or is not requested.

<Wafer Supply Signal>

A Wafer Supply signal is a signal output from the coater/developer controller 17 of the coater/developer 200 to the exposure apparatus controller 16. This signal changes to a Supplied state at the timing when the CD conveyance unit 15 supplies a wafer to the first position 13a on the inlet/outlet station 13. This signal changes to a NotSupplied state as the Input-Request signal changes to the NotReady state.

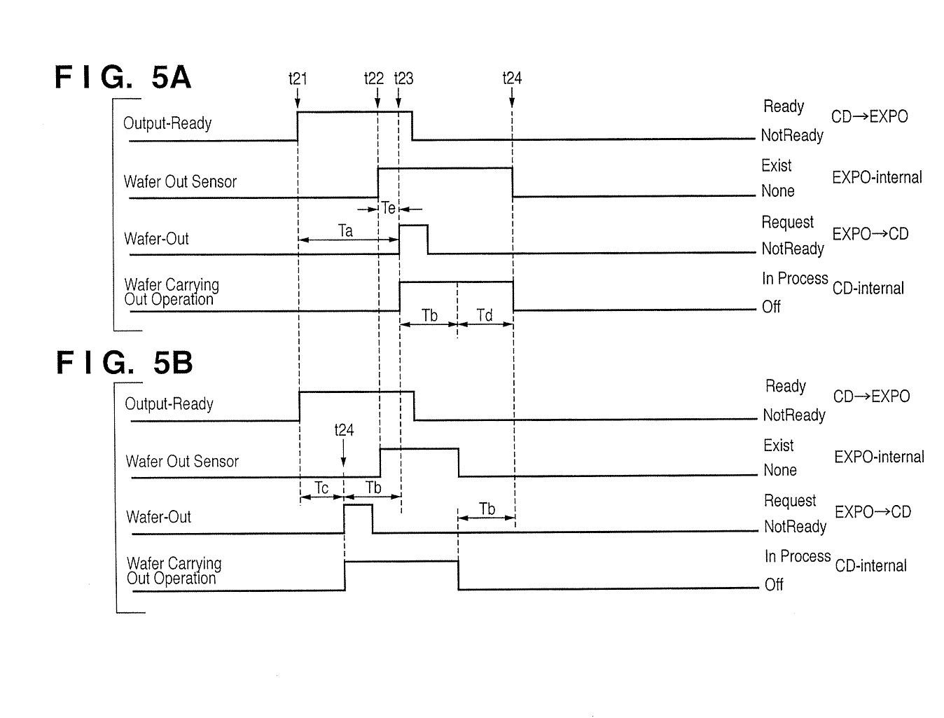

FIGS. 5A and 5B are timing charts showing operation examples for unloading a wafer from the exposure apparatus 100 to the coater/developer 200. FIG. 5A shows an operation example in the normal mode. FIG. 5B shows an operation example in the output-advancing mode. Signals shown in FIGS. 5A and 5B will be explained.

<Output-Ready Signal>

An Output-Ready signal is a conveyance completion signal output from the coater/developer controller 17 to the exposure apparatus controller 16. The Output-Ready signal is a signal representing that the coater/developer 200 is ready to control the CD conveyance unit 15 to remove a wafer from the second position 13b on the inlet/outlet station 13. This signal changes to a Ready state at the timing when the coater/developer 200 is ready to control the CD conveyance unit 15 to remove a wafer from the second position 13b on the inlet/outlet station 13. This signal changes to a NotReady state as the Wafer-Out signal changes to a Placed state.

<Wafer Out Sensor Signal>

A Wafer Out Sensor signal is a signal output from a wafer detection sensor 13Sb for detecting the existence and nonexistence of a wafer in the second position 13b on the inlet/outlet station 13. This signal is in an Exist state or None state during the existence or nonexistence of a wafer.

<Wafer-Out Signal>

A Wafer-Out signal is a wafer removing request (conveying-out request) signal (a state signal representing that wafer removal is requested) output from the exposure apparatus 100 to the coater/developer 200. The Wafer-Out signal is a signal with which the exposure apparatus 100 requests the coater/developer 200 so that the CD conveyance unit 15 removes a wafer from the second position 13b on the inlet/outlet station 13. This signal is in a Request state or NotReady state while a wafer is set or not set at the second position 13b on the inlet/outlet station 13.

<Wafer Carrying Out Operation Signal>

A Wafer Carrying Out Operation signal is a state signal of the inside of the coater/developer 200 and indicates the operation state of the CD conveyance unit 15. This signal is in an In Process state or Off state while the CD conveyance unit 15 does or does not execute conveyance.

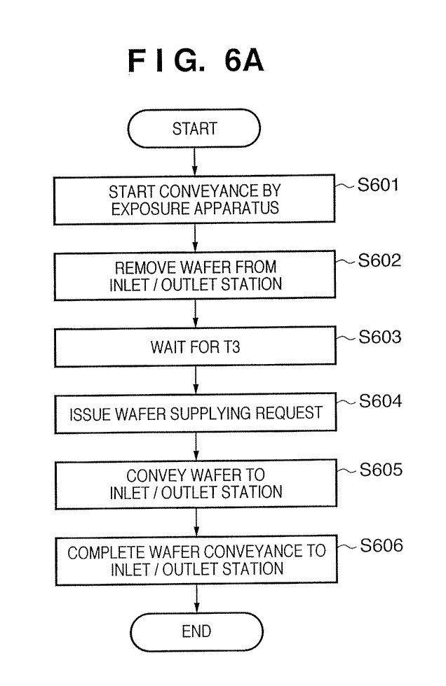

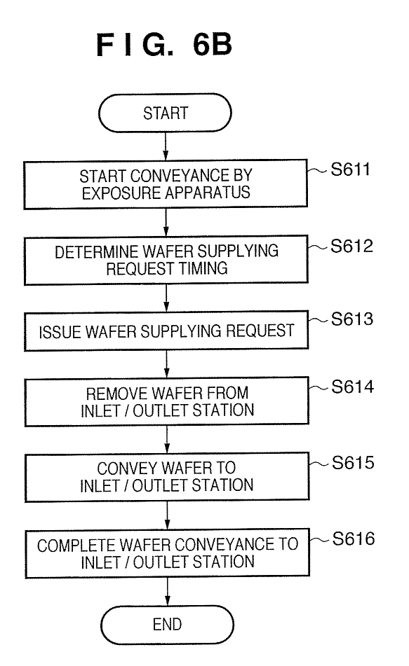

FIG. 6A is a flowchart illustrating an operation example for conveying a wafer from the coater/developer 200 to the exposure apparatus 100 in the normal mode.

In step S601, the EXPO conveyance unit 14 starts conveyance. More specifically, the EXPO conveyance unit 14 starts moving to the first position 13a on the inlet/outlet station 13. This timing corresponds to t1 shown in FIG. 4A.

In step S602, the EXPO conveyance unit 14 holds and removes a wafer from the first position 13a on the inlet/outlet station 13 and moves it to the stage unit 20. At this time, a Wafer In Sensor signal changes from an Exist state to a None state. This timing corresponds to t2 shown in FIG. 4A.

In step S603, the exposure apparatus controller 16 waits for a time T3 [sec] until the hand of the EXPO conveyance unit 14 retreats to a safety area.

In step S604, the exposure apparatus controller 16 changes a wafer loading request signal (Input-Request) from a NotReady state to a Request state. This timing corresponds to t3 shown in FIG. 4A.

In step S605, the coater/developer 200 starts conveying a wafer to the first position 13a on the inlet/outlet station 13.

A time T2 shown in FIG. 4A is the time until the hand of the CD conveyance unit 15 reaches the first position 13a on the inlet/outlet station 13. During the time T2, the hand of the CD conveyance unit 15 never enters the inlet/outlet station 13.

In step S606, the CD conveyance unit 15 sets a wafer in the first position 13a on the inlet/outlet station 13 the time T1 after the timing when the Input-Request signal changes from the NotReady state to the Request state. At this timing, the coater/developer controller 17 changes a Wafer Supply signal from a NotSupplied state to a Supplied state. This timing corresponds to t4 shown in FIG. 4A. A time T6 shown in FIG. 4A is the time from when the hand of the CD conveyance unit 15 enters the first position 13a on the inlet/outlet station 13 until it sets a wafer in the first position 13a.

FIG. 6B is a flowchart illustrating an operation example for conveying a wafer from the coater/developer 200 to the exposure apparatus 100 in the output-advancing mode.

In step S611, the EXPO conveyance unit 14 starts conveyance. More specifically, the hand of the EXPO conveyance unit 14 starts moving to the first position 13a on the inlet/outlet station 13.

In step S612, the exposure apparatus controller 16 calculates timing t11 to change a wafer supplying request (conveying-in request) signal (Input-Request) from a NotReady state to a Request state. In the output-advancing mode, the timing to change the wafer supplying request (conveying-in request) signal (Input-Request) from the NotReady state to the Request state is earlier than the natural timing by a time TP1. FIG. 4B exemplifies a case wherein the time TP1 takes a maximum value TP1max (TP1max=T1−T6). The time TP1 can be input to the input field 30 within the range of 0≦TP1≦TP1max.

TP1max will be explained. The exposure apparatus controller 16 knows beforehand a time T5 required for the EXPO conveyance unit 14 to hold and remove a wafer from the first position 13a on the inlet/outlet station 13 from timing t1 when the hand of the EXPO conveyance unit 14 starts moving to the inlet/outlet station 13.

TP1max is given by (T2−T3). If TP1max, for example, TP1 is larger than (T2−T3), the hand of the CD conveyance unit 15 enters the inlet/outlet station 13 before the hand of the EXPO conveyance unit 14 retreats to the safety area, and they may collide with each other.

The exposure apparatus controller 16 calculates timing t11 to change the wafer supplying request (conveying-in request) signal (Input-Request) from the NotReady state to the Request state, in accordance with:

t11=t1+T5+T3−TP1 (1)

In step S613, the exposure apparatus controller 16 changes the wafer supplying request (conveying-in request) signal (Input-Request) from the NotReady state to the Request state at the calculated timing t11.

In step S614, the EXPO conveyance unit 14 holds and removes a wafer from the first position 13a on the inlet/outlet station 13 and moves it to the stage unit 20. At this time, a Wafer In Sensor signal changes from an Exist state to a None state. This timing corresponds to t2 shown in FIG. 4B.

In step S615, the coater/developer 200 starts conveying a wafer to the first position 13a on the inlet/outlet station 13. Parallel to this processing, the EXPO conveyance unit 14 continues conveying the wafer in the first position 13a on the inlet/outlet station 13 to the stage unit 20.

In step S616, the CD conveyance unit 15 sets a wafer in the first position 13a on the inlet/outlet station 13 the time T1 after the timing when the Input-Request signal changes from the NotReady state to the Request state. At this timing, the coater/developer controller 17 changes a Wafer Supply signal from a NotSupplied state to a Supplied state. This timing corresponds to t12 shown in FIG. 4B.

The exposure apparatus 100 generates the wafer supplying request (conveying-in request) signal (Input-Request) at a timing earlier than the natural timing by the advancing time TP1. Hence, the coater/developer 200 supplies a wafer to the first position 13a on the inlet/outlet station 13 at a timing earlier than the natural timing by TP1.

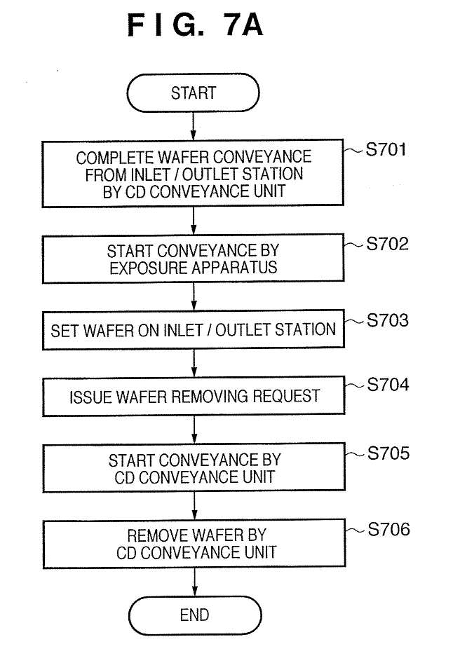

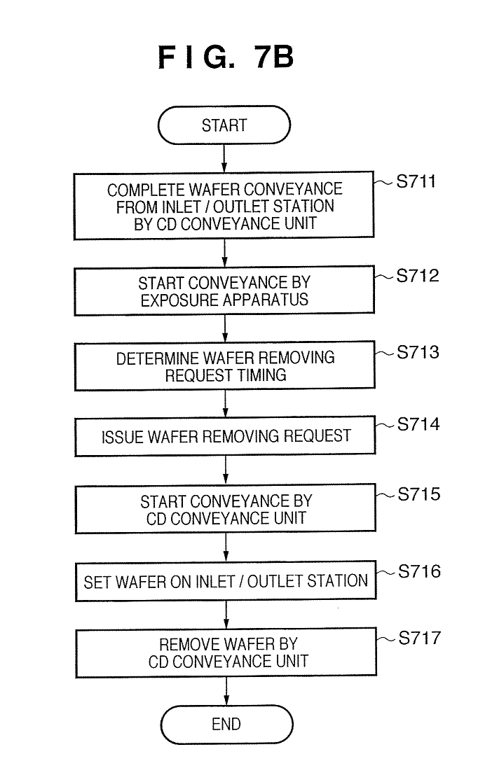

FIG. 7A is a flowchart illustrating an operation example for unloading a wafer from the exposure apparatus 100 to the coater/developer 200 in the normal mode.

In step S701, the coater/developer controller 17 changes a conveyance completion signal (Output-Ready) at the timing when the CD conveyance unit 15 completes conveyance processing for removing a wafer from the second position 13b on the inlet/outlet station 13 and conveying it to the developing unit. More specifically, at this timing, the coater/developer controller 17 changes the conveyance completion signal (Output-Ready) from a NotReady state to a Ready state. This timing corresponds to t21 shown in FIG. 5A.

In step S702, the EXPO conveyance unit 14 starts conveying a wafer to the second position 13b on the inlet/outlet station 13.

In step S703, the EXPO conveyance unit 14 completes the setting of the wafer in the second position 13b on the inlet/outlet station 13. At this timing, a signal (Wafer Out Sensor) output from the wafer detection sensor 13Sb changes from a None state to an Exist state. This timing corresponds to t22 shown in FIG. 5A.

In step S704, the exposure apparatus controller 16 waits for a time Ta from timing t21 when the coater/developer controller 17 changes the conveyance completion signal (Output-Ready) from the NotReady state to the Ready state and sends it to the exposure apparatus controller 16. The exposure apparatus controller 16 then changes a wafer removing request (conveying-out request) signal (Wafer-Out) from a NotReady state to a Request state. This timing corresponds to t23 shown in FIG. 5A. Referring to FIG. 5A, a time Te is a time from when the signal (Wafer Out Sensor) output from the wafer detection sensor 13Sb changes from the None state to the Exist state until the hand of the EXPO conveyance unit 14 in the exposure apparatus 100 retreats to the safety area.

In step S705, the CD conveyance unit 15 starts wafer conveyance. More specifically, the hand of the CD conveyance unit 15 in the coater/developer 200 starts moving to the second position 13b on the inlet/outlet station 13.

A time Tb shown in FIG. 5A is the time until the hand of the CD conveyance unit 15 reaches the second position 13b on the inlet/outlet station 13. During the time Tb, the hand of the CD conveyance unit 15 never enters the inlet/outlet station 13.

In step S706, the CD conveyance unit 15 removes the wafer from the second position 13b on the inlet/outlet station 13. The signal (Wafer Out Sensor) output from the wafer detection sensor 13Sb changes from the Exist state to the None state.

FIG. 7B is a flowchart illustrating an operation example for unloading a wafer from the exposure apparatus 100 to the coater/developer 200 in the output-advancing mode.

In step S711, the coater/developer controller 17 changes a conveyance completion signal (Output-Ready) at the timing when the CD conveyance unit 15 completes conveyance processing for removing a wafer from the second position 13b on the inlet/outlet station 13 and conveying it to the developing unit. More specifically, at this timing, the coater/developer controller 17 changes the conveyance completion signal (Output-Ready) from a NotReady state to a Ready state. This timing corresponds to t21 shown in FIG. 5B.

In step S712, the EXPO conveyance unit 14 starts conveying a wafer to the second position 13b on the inlet/outlet station 13.

In step S713, the exposure apparatus controller 16 calculates a timing to change a wafer removing request (conveying-out request) signal (Wafer-Out) from a NotReady state to a Request state. In the output-advancing mode, the timing to change the wafer removing request (conveying-out request) signal (Wafer-Out) from the NotReady state to the Request state is earlier than the natural timing by a time TP2. FIG. 5B exemplifies a case wherein the time TP2 takes a maximum value TP2max (TP2max=Tb). The time TP2 can be input to the input field 32 within the range of 0≦TP2≦TP2max.

TP2max will be explained. The time Tb is the time until the hand of the CD conveyance unit 15 reaches the second position 13b on the inlet/outlet station 13. During the time Tb, the hand of the CD conveyance unit 15 never enters the inlet/outlet station 13. If TP2max, that is, TP2 is larger than Tb, the hand of the CD conveyance unit 15 in the coater/developer 200 may enter the inlet/outlet station 13 before the hand of the EXPO conveyance unit 14 retreats to the safety area, and they may collide with each other.

The exposure apparatus 100 knows beforehand, as performance information, a time Ta required to set a wafer at the second position 13b on the inlet/outlet station 13 from timing t21 when the hand of the EXPO conveyance unit 14 starts moving to the second position 13b.

The exposure apparatus controller 16 calculates a timing to change a wafer removing request (conveying-out request) signal (Wafer-Out) from a NotReady state to a Request state, in accordance with:

t24=t21+Ta−TP2 (2)

In step S714, the exposure apparatus controller 16 changes the wafer remove request signal (Wafer-Out) from the NotReady state to the Request state at timing t24.

In step S715, the CD conveyance unit 15 in the coater/developer 200 starts wafer conveyance. More specifically, the hand of the CD conveyance unit 15 in the coater/developer 200 starts moving to the second position 13b on the inlet/outlet station 13.

In step S716, the EXPO conveyance unit 14 in the exposure apparatus 100 completes the setting of the wafer in the second position 13b on the inlet/outlet station 13 the time Ta after timing t21.

In step S717, the CD conveyance unit 15 in the coater/developer 200 removes the wafer from the second position 13b on the inlet/outlet station 13. A signal (Wafer Out Sensor) output from the wafer detection sensor 13Sb changes from an Exist state to a None state.

The exposure apparatus 100 generates the wafer removing request (conveying-out request) signal (Wafer-Out) at a timing earlier than the natural timing by the advancing time TP2. Hence, the coater/developer 200 removes a wafer from the second position 13b on the inlet/outlet station 13 at a timing earlier than the natural timing by TP2.

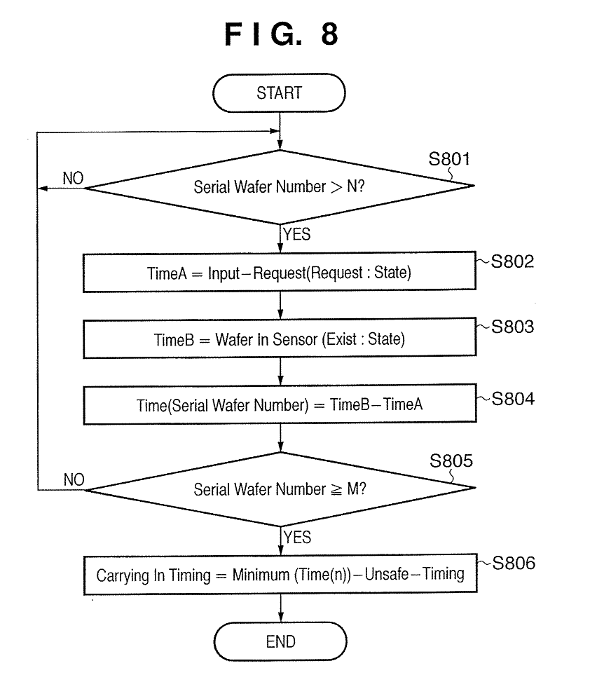

FIG. 8 is a flowchart illustrating the operation of the exposure apparatus controller 16 in a learning mode (wafer supplying request). As described above, the learning mode (wafer supplying request) is set ON upon inputting a check mark to the ON box 34a. In the learning mode (wafer supplying request), the time from when the exposure apparatus 100 outputs a wafer supplying request (conveying-in request) signal (Input-Request) to the coater/developer 200 until the coater/developer 200 supplies a wafer to the first position 13a on the inlet/outlet station 13 is measured. The offset time TP1 of a timing defined by the wafer supplying request (conveying-in request) signal is determined based on the measurement result.

In the following processing, N and M are set in advance using, for example, the input/output unit 18.

In step S801, the exposure apparatus controller 16 determines whether the Serial Wafer Number is larger than N. If the Serial Wafer Number is larger than N, the processing advances to step S802. If the Serial Wafer Number is equal to or smaller than N, the processing waits until it exceeds N. The Serial Wafer Number is initialized to 1 at the start of a lot, and counted up every time a wafer is loaded to the exposure apparatus 100.

In step S802, the exposure apparatus controller 16 stores the current time in a variable TimeA at timing t3 when a wafer supplying request (conveying-in request) signal (Input-Request) changes from a NotReady state to a Request state.

In step S803, the exposure apparatus controller 16 stores the current time in a variable TimeB at timing t4 when a Wafer In Sensor signal changes from a None state to an Exist state.

In step S804, the exposure apparatus controller 16 calculates the difference between the variables TimeA and TimeB, and stores it in an array variable Time (Serial Wafer Number).

In step S805, the exposure apparatus controller 16 determines whether the Serial Wafer Number is equal to or larger than M. If the Serial Wafer Number is equal to or larger than M, the processing advances to step S806. If the Serial Wafer Number is smaller than M, the processing returns to step S801.

In step S806, the exposure apparatus controller 16 calculates the minimum value of the array variable Time (Serial Wafer Number), subtracts the time T6 from the calculated minimum value, and determines the advancing time TP1 based on the resultant time. It is possible to determine, as the advancing time TP1, the time obtained by subtracting the time T6 from the minimum value of the array variable Time (Serial Wafer Number). Alternatively, the exposure apparatus controller 16 may subtract the time T6 and a time delay from the minimum value of the array variable Time (Serial Wafer Number), and determine the resultant time as the advancing time TP1.

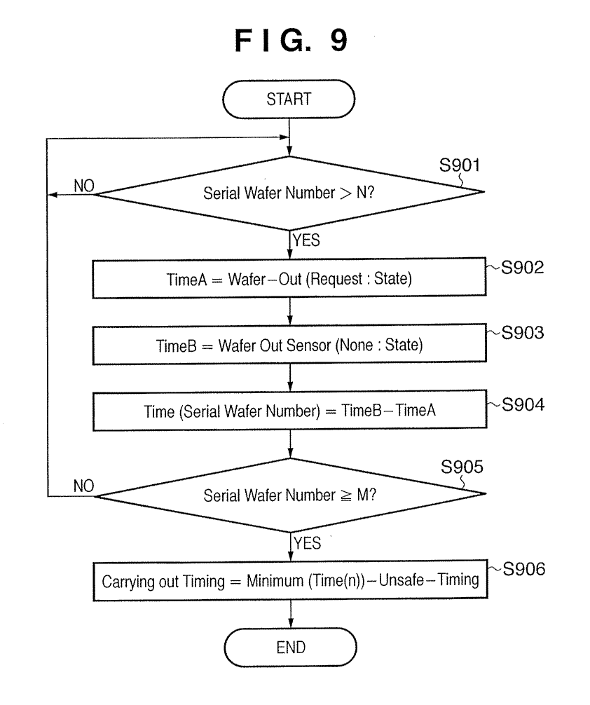

FIG. 9 is a flowchart illustrating the operation of the exposure apparatus controller 16 in a learning mode (wafer removing request). As described above, the learning mode (wafer removing request) is set ON upon inputting a check mark to the ON box 36a. In the learning mode (wafer removing request), the time from when the exposure apparatus 100 outputs a wafer removing request (conveying-out request) signal (Wafer-Out) to the coater/developer 200 until the coater/developer 200 removes the wafer from the second position 13b on the inlet/outlet station 13 is measured. The offset time of a timing defined by the wafer removing request (conveying-out request) signal is determined based on the measurement result.

In step S901, the exposure apparatus controller 16 determines whether the Serial Wafer Number is larger than N. If the Serial Wafer Number is larger than N, the processing advances to step S902. If the Serial Wafer Number is equal to or smaller than N, the processing waits until it exceeds N. The Serial Wafer Number is initialized to 1 at the start of a lot, and counted up every time a wafer is loaded to the exposure apparatus 100.

In step S902, the exposure apparatus controller 16 stores the current time in a variable TimeA at timing t23 when a wafer removing request (conveying-out request) signal (Wafer-Out) changes from a NotReady state to a Request state.

In step S903, the exposure apparatus controller 16 stores the current time in a variable TimeB at timing t24 when a Wafer Out Sensor signal changes from an Exist state to a None state.

In step S904, the exposure apparatus controller 16 calculates the difference between the variables TimeA and TimeB, and stores it in an array variable Time (Serial Wafer Number).

In step S905, the exposure apparatus controller 16 determines whether the Serial Wafer Number is equal to or larger than M. If the Serial Wafer Number is equal to or larger than M, the processing advances to step S906. If the Serial Wafer Number is smaller than M, the processing returns to step S901.

In step S906, the exposure apparatus controller 16 calculates the minimum value of the array variable Time (Serial Wafer Number), subtracts the time Td from the calculated minimum value, and determines the advancing time TP2 based on the resultant time. It is possible to determine, as the advancing time TP2, the time obtained by subtracting the time Td from the minimum value of the array variable Time (Serial Wafer Number). Alternatively, the exposure apparatus controller 16 may subtract the time Td and a margin from the minimum value of the array variable Time (Serial Wafer Number), and determine the resultant time as the advancing time TP2.

As described above, the exposure apparatus sends a signal to the coater/developer at a timing earlier than the natural timing to advance the wafer conveyance timing, thus improving the throughput. To the contrary, the coater/developer can send a signal to the exposure apparatus at a timing earlier than the natural timing to advance the wafer conveyance timing, thus improving the throughput.

The time from when the wafer supplying request (conveying-in request) signal (Input-Request) changes from the NotReady state to the Request state until the hand of the CD conveyance unit 15 in the coater/developer reaches the inlet/outlet station 13 changes depending on a coating/developing recipe and the performance of the coater/developer.

The time from when the wafer removing request (conveying-out request) signal (Wafer-Out) changes from the NotReady state to the Request state until the hand of the CD conveyance unit 15 in the coater/developer reaches the inlet/outlet station 13 changes depending on a coating/developing recipe and the performance of the coater/developer.

In the above-described embodiment, the EXPO conveyance unit and CD conveyance unit exchange a wafer via the wafer inlet/outlet station. However, the EXPO conveyance unit and CD conveyance unit may exchange a wafer directly.

Although the above-described embodiment exemplifies the case wherein the present invention is applied to wafer exchange between the exposure apparatus and the coater/developer, the present invention is not limited to this. That is, the present invention is widely applicable to object exchange between an external apparatus and a processing apparatus including a processing unit which processes an object. The above-described exposure apparatus is an example of the processing apparatus. The above-described coater/developer is an example of the external apparatus.

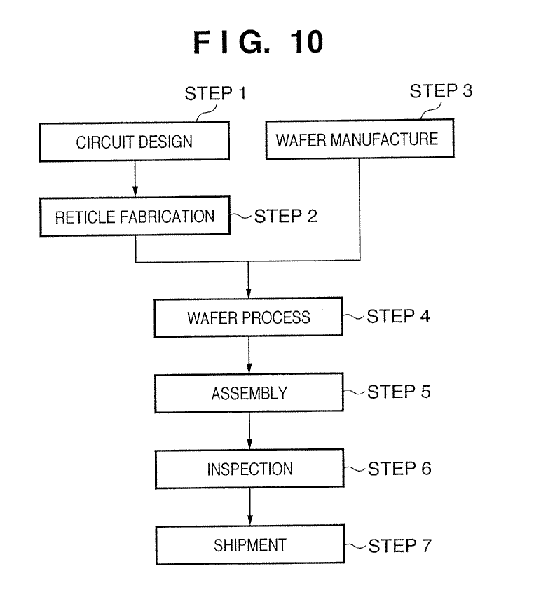

A device manufacturing method using the above-described exposure apparatus or lithography system will be explained next. FIG. 10 is a flowchart illustrating the sequence of the overall semiconductor device manufacturing process. In step 1 (circuit design), the circuit of a semiconductor device is designed. In step 2 (reticle fabrication), a reticle (also called an original or mask) is fabricated based on the designed circuit pattern. In step 3 (wafer manufacture), a wafer (also called a substrate) is manufactured using a material such as silicon. In step 4 (wafer process) called a preprocess, an actual circuit is formed on the wafer by lithography using the reticle and wafer. In step 5 (assembly) called a post-process, a semiconductor chip is formed using the wafer manufactured in step 4. This step includes processes such as assembly (dicing and bonding) and packaging (chip encapsulation). In step 6 (inspection), inspections including operation check test and durability test of the semiconductor device manufactured in step 5 are performed. A semiconductor device is completed with these processes and shipped in step 7.

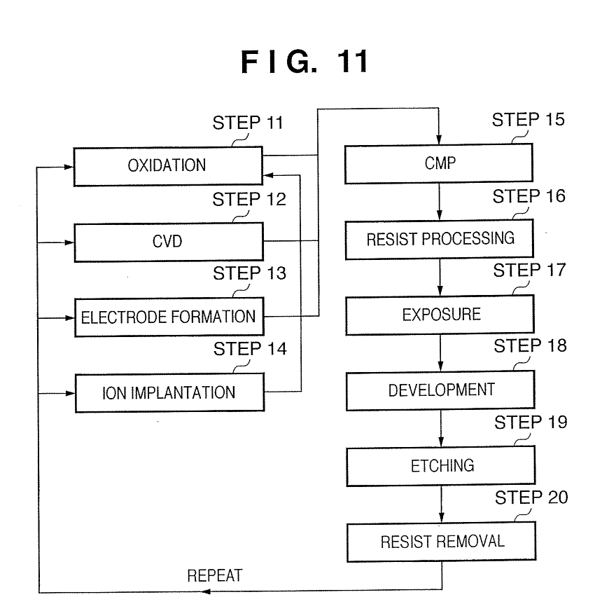

FIG. 11 is a flowchart illustrating the detailed sequence of the wafer process. In step 11 (oxidation), the wafer surface is oxidized. In step 12 (CVD), an insulating film is formed on the wafer surface. In step 13 (electrode formation), an electrode is formed on the wafer by deposition. In step 14 (ion implantation), ions are implanted into the wafer. In step 15 (CMP), the insulating film is planarized by CMP. In step 16 (resist processing), the coater/developer in the above-described lithography system applies a photosensitive agent to the wafer. In step 17 (exposure), the exposure apparatus in the above-described lithography system forms a latent image pattern on the resist by exposing the wafer coated with the photosensitive agent to light via the mask on which the circuit pattern is formed. In step 18 (development), the coater/developer in the above-described lithography system develops the latent image pattern formed on the resist on the wafer, to form a physical resist pattern. In step 19 (etching), the layer or substrate under the resist pattern is etched through a portion where the resist pattern opens. In step 20 (resist removal), any unnecessary resist remaining after etching is removed. By repeating these steps, a multilayered structure of circuit patterns is formed on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-269021, filed Sep. 29, 2006, which is hereby incorporated by reference herein in its entirety.

What is claimed is:

1. A processing apparatus comprising:
a processing unit configured to process an object; and a controller configured to send a signal for requesting an external apparatus to perform conveyance of the object into or out of the processing apparatus before the processing apparatus enters a state in which the external apparatus can perform the conveyance.

2. The processing apparatus according to claim 1, wherein
the state is a state in which the external apparatus can convey the object into the processing apparatus, and
said controller is configured to send a signal for requesting the external apparatus to convey the object into the processing apparatus.

3. The processing apparatus according to claim 1, wherein
the state is a state in which the external apparatus can convey the object out of the processing apparatus, and
said controller is configured to send a signal for requesting the external apparatus to convey the object out of the processing apparatus.

4. The processing apparatus according to claim 1, wherein said controller is configured to output the signal at a time earlier than a predicted time, at which the processing apparatus would enter the state, by an advancing time.

5. The processing apparatus according to claim 4, further comprising a user interface configured to receive information to set the advancing time.

6. The processing apparatus according to claim 4, wherein said controller is configured to determine the advancing time by learning.

7. The processing apparatus according to claim 1, wherein the processing unit includes an exposure unit configured to expose a substrate to light.

8. The processing apparatus according to claim 7, wherein the signal is a signal for requesting the external apparatus to convey the substrate coated with a photosensitive agent into the processing apparatus.

9. The processing apparatus according to claim 7, wherein the signal is a signal for requesting the external apparatus to convey the substrate that has been exposed to light out of the processing apparatus.

10. A method of manufacturing a device, said method comprising:
exposing a substrate to light using a processing apparatus as defined in claim 7;
developing the exposed substrate; and
processing the developed substrate to manufacture the device.
